(19) United States
(12) Patent Application Publication
(10) Pub. No.: US 2014/0143971 A1
(43) Pub. Date: May 29, 2014

(54) WIPER BLADE FOR CLEANING WINDOWS, IN PARTICULAR OF MOTOR VEHICLES

(71) Applicant: Waldemar Ernst, Vaihingen/Enz (DE)

(72) Inventor: Waldemar Ernst, Vaihingen/Enz (DE)

(73) Assignee: ROBERT BOSCH GMBH, Stuttgart (DE)

(21) Appl. No.: 14/126,641

(22) PCT Filed: Apr. 26, 2012
(86) PCT No.: PCT/EP2012/057656

§ 371 Date: Dec. 16, 2013

(30) Foreign Application Priority Data
Jun. 15, 2011 (DE) 10 2011 077 516.1

(51) Int. Cl. B60S 1/38

(52) U.S. Cl. CPC B60S 1/3882
USPC 15/250.38

(57) ABSTRACT

The invention relates to a wiper blade for wiping windows, in particular motor vehicle windows, comprising a support element (12) for accommodating a wiper strip (14), to which support element a connecting device (20) is fastened, which connecting device has a part (15) on the wiper blade side having projections (50, 52) that engage behind the support element (12) at least in some regions. The invention further relates to a method for producing such a wiper blade. According to the invention, at least one shim element (62, 64) is arranged between the support element (12) and the engagement of the projections (50, 52).

### BACKGROUND OF THE INVENTION

The invention relates to wiper blades for wiping windscreens, particularly vehicle windscreens, having a support element for receiving a wiper strip to which a connecting device is fastened, the connecting device having a part on the wiper blade side with projections which engage behind the support element at least in places. In such wiper blades, the support element should guarantee the most uniform distribution possible of the wiper blade contact pressure emanating from the wiper arm on the windscreen over the entire wiping area covered by the wiper blade. Through a corresponding curvature of the unloaded support element—in other words when the wiper blade does not rest against the windscreen—the ends of the wiper strip which are completely applied to the windscreen when the wiper blade is in operation are loaded to the windscreen by the then tensioned support element, even if the curvature radii of spherically curved vehicle windscreens change with each wiper blade position. The curvature of the wiper blade must therefore be slightly greater than the greatest curvature measured in the wiping area on the windscreen to be wiped. A connecting device is fastened to the support element, by means of which the connection to the wiper arm is made.

EP 1564094 B1 discloses that the connecting device can be fastened to the support element by means of projections which extend through the support element and are flared on an opposite side. Since the alternating bends which occur in this area during the wiping operation are considerable, the projections are also subject to an extreme load. The projections cannot be enlarged arbitrarily, as this would require the openings required in the support element to be enlarged too, which would lead to a significant weakening of the support element in this highly sensitive region.

### SUMMARY OF THE INVENTION

The wiper blade according to the invention has the advantage that relative movements between the projections and the support element can be at least partially absorbed by the additional shim elements, which leads to a removal of the load from areas at risk of notching. The diameters of the projections and therefore those of the openings may be kept at a size determined mainly by the tensile stresses and less so by the shear stresses which occur.

The measures according to the invention give rise to advantageous developments of the wiper blade. Hence, a favorable friction value occurs when the shim elements are made of the same material as the part of the connecting device on the wiper blade side, which part is usually made from a thermoplastic material.

If the shim elements are integrally formed on the part of the connecting device on the wiper blade side in an articulated, non-detachable manner, the process reliability during production of the wiper blade increases.

The movability, particularly the ability of the support element to bend relative to the projections, is increased by a convexly held side facing the support element.

The freedom of the bending movement between the support element and the part on the wiper blade side with its projections is improved when the side of the part on the wiper blade side facing the support element exhibits convex areas in the region of the projections. On the one hand, these allow a certain distance between the support element and the side of the part on the wiper blade side facing the support element, which distance may be larger or smaller according to the curvature radius of the support element, depending on the wiping position on the windscreen. On the other hand, they allow a certain roll-off of the support element on the convex area. These convex areas may also be designed as separate shim elements and therefore be better adaptable to the working conditions.

The method according to the invention for producing a wiper blade is characterized in that it offers a simple way of producing the wiper blades according to the invention.

### BRIEF DESCRIPTION OF THE DRAWINGS

In the drawing:

FIG. 1 shows a wiper blade according to the invention in a perspective view with the wiper arm indicated using a dot-dash line and the surface of a windscreen indicated using a dot-dash line,

FIG. 2 shows a view according to II-II in FIG. 1,

FIG. 3 shows a schematic representation of the view according to FIG. 2 with only one spring strip,

FIG. 4 shows a schematic view in the viewing direction IV in FIG. 1 with only one end cap and

FIGS. 5 to 7 show embodiments in a sectional detail view in each case.

### DETAILED DESCRIPTION

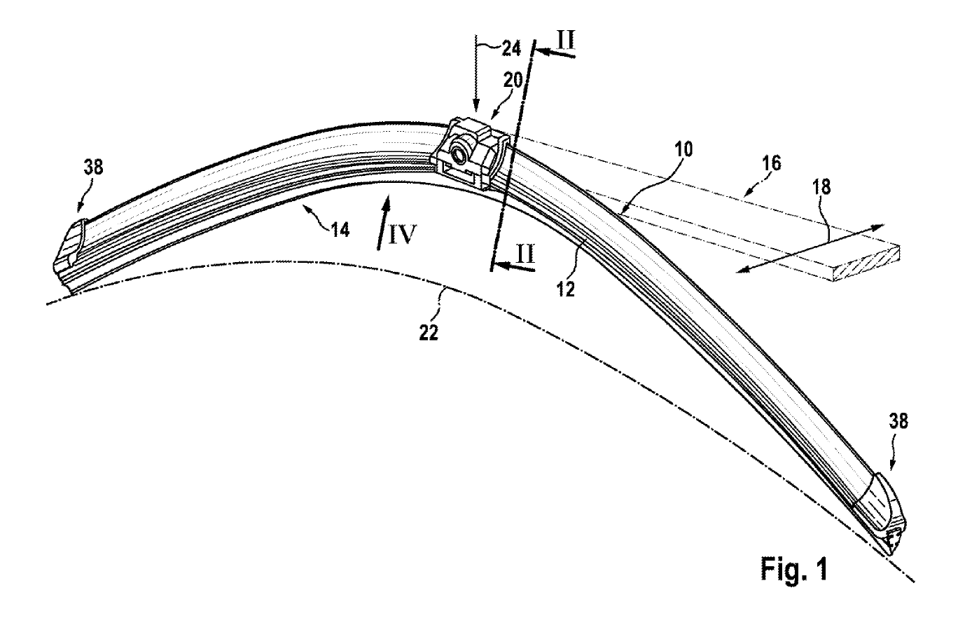

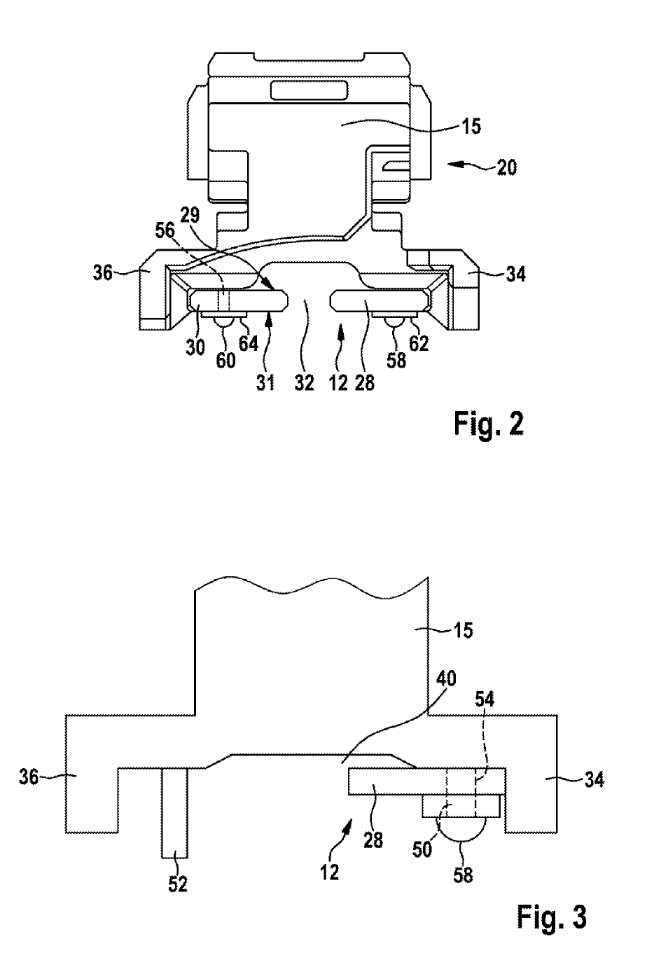

A wiper blade 10 shown in FIG. 1 has a resilient support element 12 elongated in a strip-like manner (FIGS. 1 and 2), on the lower strip side 13 facing the windscreen whereof is fastened an elongated, rubber-elastic wiper strip 14 in a manner parallel to the longitudinal axis. On the upper strip side 11 facing away from the windscreen of the support element 12 also to be referred to as a spring strip, the part 15 on the wiper blade side of a connecting device 20 is arranged in the center portion of said support element, with the help of which connecting device the wiper blade 10 can be detachably connected to a wiper arm 16 depicted by a dot-dash line in FIG. 1. The wiper arm 16 driven in oscillating fashion in the direction of a double arrow 18 in FIG. 1 is depicted in the direction of an arrow 24 to the windscreen to be wiped—loaded to the windscreen of a vehicle, for example—the surface of which is depicted in FIG. 1 by a dot-dash line 22. Since the line 22 is intended to represent the greatest curvature of the windscreen surface, it should be clearly evident that the curvature of the as yet unloaded wiper blade with its two ends resting against the windscreen is greater than the maximum windscreen curvature (FIG. 1). Under the contact pressure (arrow 24), the wiper blade 10 with its wiper lip 26 is applied to the windscreen surface 22 over its entire length. Tension develops as a result in the resilient support element 12 which is usually made of metal, said tension ensuring a proper bearing of the wiper strip 14 or of the wiper lip 26 against the windscreen surface 22 over its entire length and also a uniform distribution of the contact pressure (arrow 24).

The particular embodiment of the wiper blade according to the invention will be described in greater detail below.

It can be seen in FIG. 2 that the support element 12 is made up of two spring strips 28 and 30 separated from one another, which are spaced apart from one another and create a gap 32. The part 15 of the connecting device 20 on the wiper blade side exhibits two receiving means 34 and 36 in a lower region, in which the spring strips 28 and 30 each rest laterally. The receiving means 34 and 36 therefore rest against the sides of the spring strips 28 and 30, while the part of the connecting device 20 corresponding to the wiper arm 16 is arranged on the convex side 29 of the support element 12 and the concave side 31 lies opposite this.

The part 15 of the connecting device 20 on the wiper blade side is represented schematically in FIG. 3, wherein the corresponding spring strip 28 is drawn in the receiving means 34, while the spring strip 30 does not lie in the corresponding receiving means 36. In the region above the spring strips 28 and 30 and also above the gap 32, the part 15 exhibits a recess 40 into which a top part of a wiper strip comes to lie when the wiper blade 10 is assembled. Projections 50 and 52 are arranged in the region between the receiving means 34 and 36, said projections extending parallel to the receiving means 34 and 36 in the direction of the spring strips 28 and 30 to be received starting from the part 15. The supporting element 12 or the spring strips 28 and 30 thereof are therefore equipped with openings 54 and 56 to receive the projections 50 and 52.

The outer end of the projections 50 and 52 is formed into a head 58 and 60, respectively, in each case (FIG. 2). A shim element 62, 64 is inserted between each head 58, 60 and the respective spring strip 28, 30.

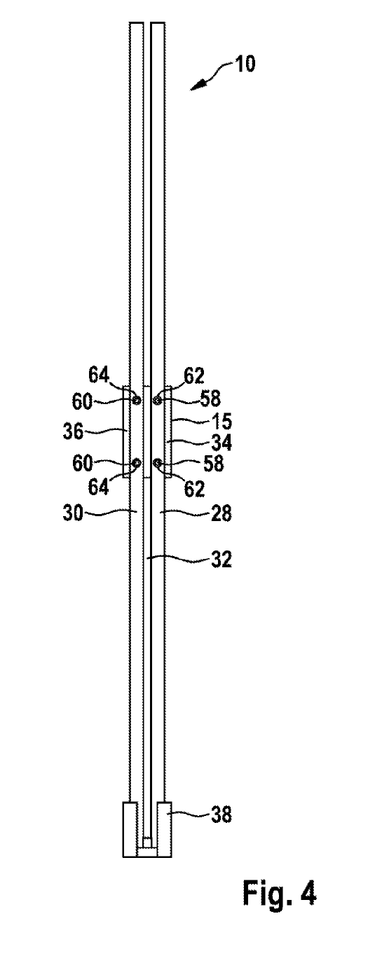

The wiper blade 10 depicted from below in FIG. 4, which is drawn without the wiper strip 14 or wiper lip 26, shows the spring strips 28 and 30, the gap 32 and also the receiving means 34 and 36 of the part 15 of the connecting device 15 on the wiper blade side. It is evident that in this embodiment of the wiper blade 10 the spring strips 28 and 30 are completely separate from one another and only held together by the part 15 of the connecting device 20 on the wiper blade side or via end caps 38, only one of which is depicted on an end in FIG. 4. The lower ends of the projections 50 and 52 are furthermore depicted projecting through the spring strips 28 and 30. As already evident in FIG. 2, the projections 50 and 52 each exhibit an enlarged head 58 and 60, via which the spring strips 28 and 30 are connected to the part 15 in a form-fitted manner. The heads 58 and 60 are usually produced by supplying heat to the outer ends of the projections 50 and 52.

Between the heads 58 and 60 and the spring strips 28 and 30, the shim elements 62 and 64 can be identified as an outer ring. In this exemplary embodiment, the shim elements 62, 64 are of annular design similar to a shim element. They are made of the same material as the projections 50, 52 in this case and therefore as the part 15 of the connecting device 20 on the wiper blade side.

In the following embodiments the same parts are each referred to using the same reference numbers.

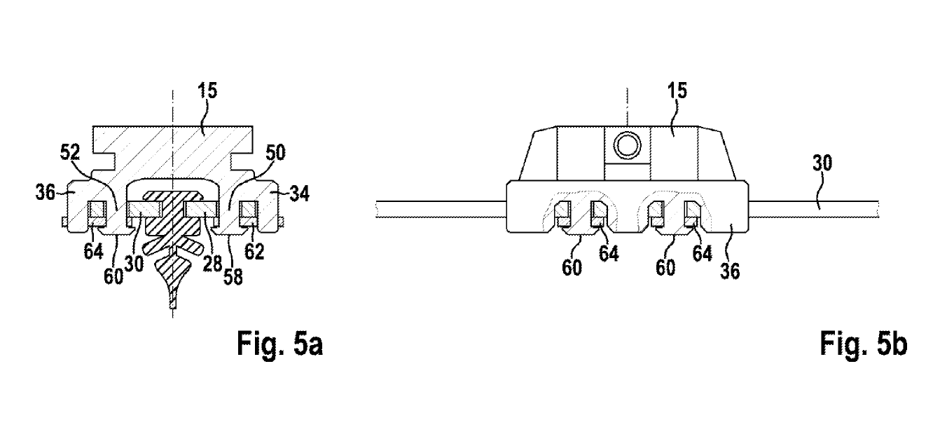

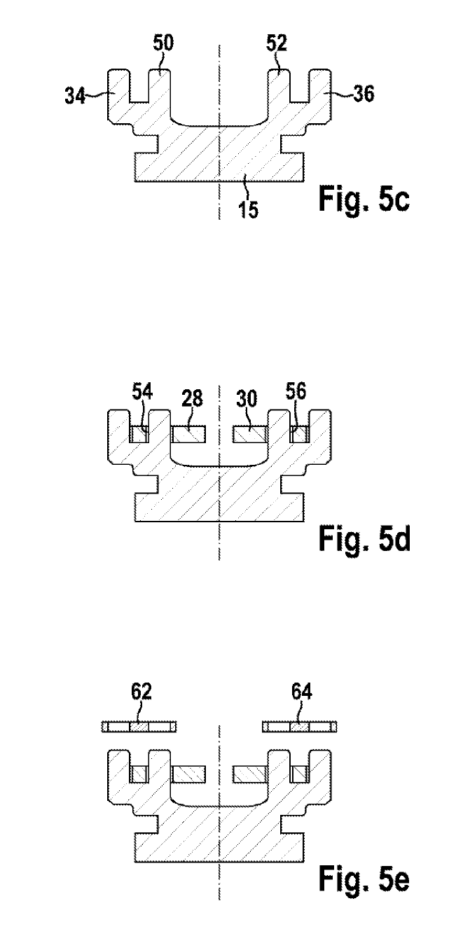

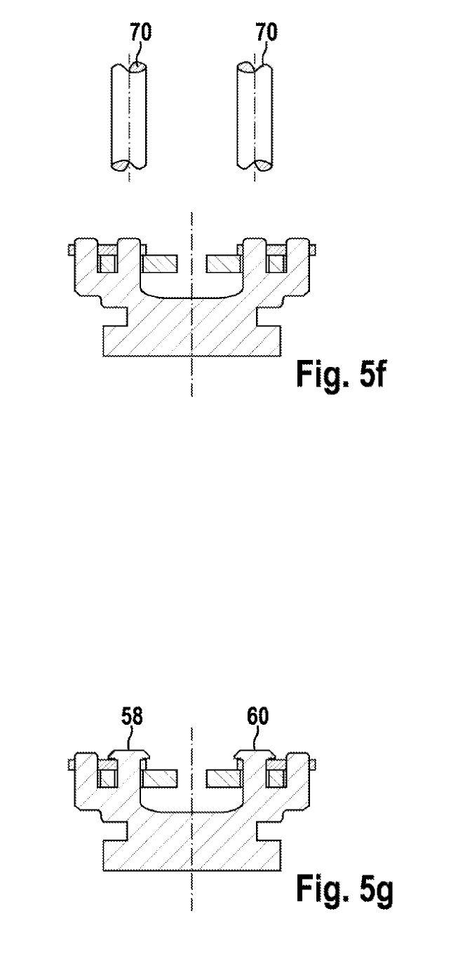

In FIG. 5 an embodiment of the wiper blade 10 according to the invention is presented in the partial images a and b, wherein 5 a corresponds to the presentation according to FIGS. 2 and 5 b is a partially broken out side representation. The shim elements 62, 64 not only overlap the projections 50, 52 but also part of the receiving means 34, 36, which are cut out correspondingly for this purpose.

Individual steps for producing the connection between the part 15 on the wiper blade side and the spring strips 28, 30 of the support element 12 are represented in FIGS. 5 c to g. In 5 c, the part 15 on the wiper blade side is presented with its projections 58, 60 pointing upwards. The spring strips 28, 30 are put over these projections 58, 60, so that they receive the projections 58, 60 in their openings 54, 56 (FIG. 5 d).

The shim elements 62, 64 are put over the projections 54, 56 in FIG. 5e, wherein in this exemplary embodiment the shim elements 62, 64 have additional openings to receive parts of the receiving means 34, 36. This helps to stabilize the connection.

It can be seen in FIG. 5 f that the structure preassembled in this manner is worked by means of ultrasound sonotrodes 70. It is evident from FIG. 5 g that by means of the sonotrodes 70 the heads 58 and 60 were integrally formed on the projections 52 and 60.

In further process steps no longer illustrated, the wiper strip 14 can now be inserted, the end caps 38 fitted and the connecting device completed where appropriate.

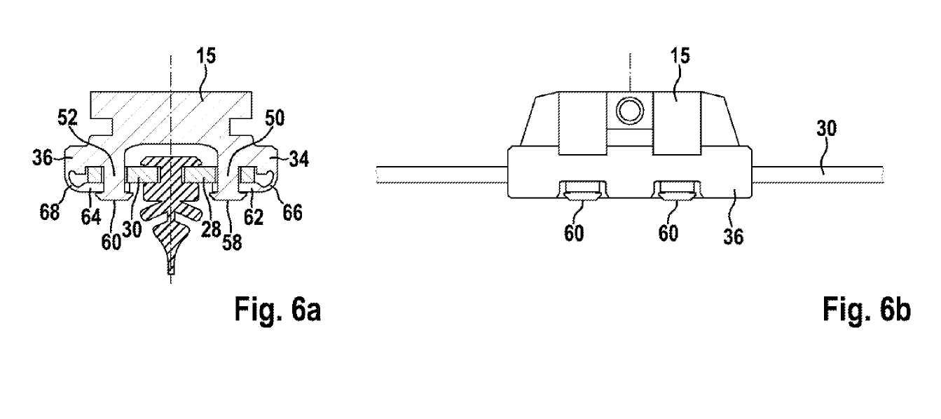

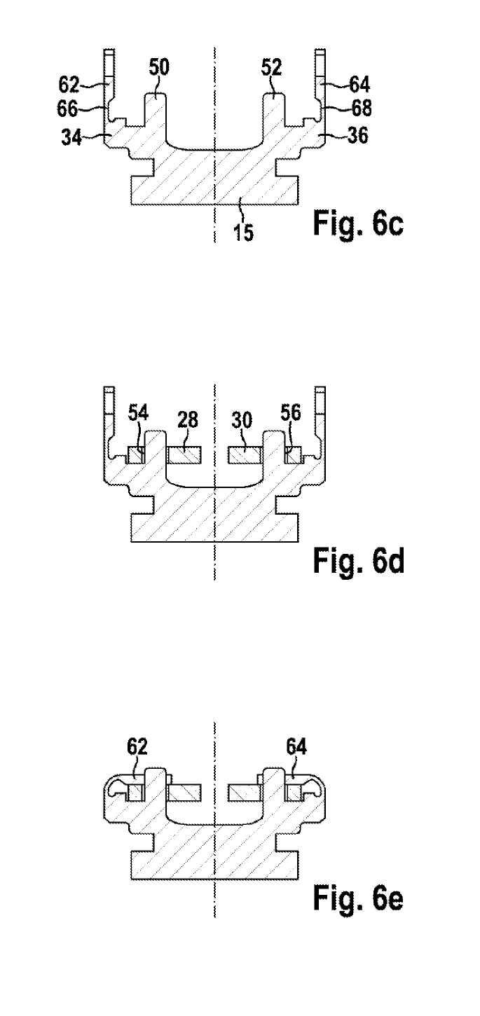

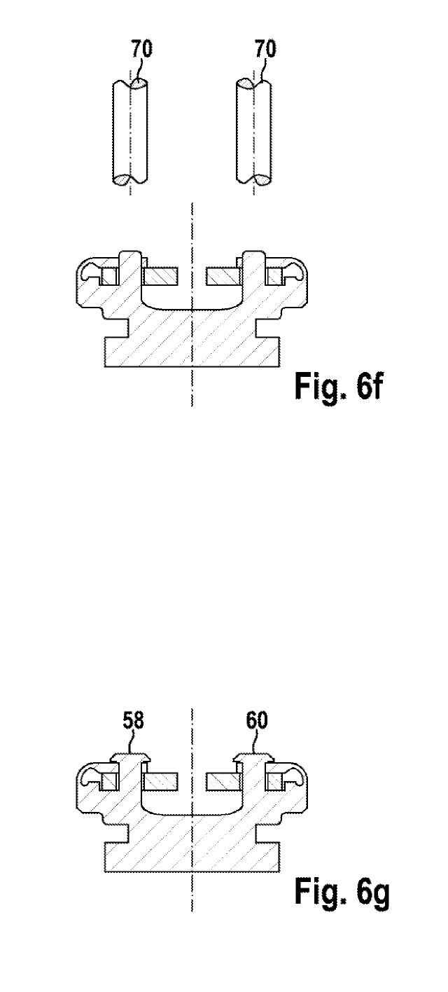

A further embodiment of the wiper blade 10 according to the invention is depicted in the partial images a and b in FIG. 6, wherein 6 a corresponds to the depiction according to FIGS. 2 and 6 b is a side view. The shim elements 62, 64 are connected to the receiving means 34, 36 by means of integral hinge joints 66, 68 in a substance-bonded manner.

Individual steps for producing the connection between the part 15 on the wiper blade side and the spring strips 28, 30 of the support element 12 are depicted in FIGS. 6 c to g. In 6 c the part 15 on the wiper blade side with its projections 58, 60 is shown pointing upwards. In addition, the shim elements 62, 64 are integrally formed on the outer ends of the receiving means 34, 36 via integral hinge joints 66, 68. The spring strips 28, 30 are put over the projections 58, 60, so that they receive the projections 58, 60 in their openings 54, 56 (FIG. 6 d).

In FIG. 6 e the shim elements 62, 64 are now folded over the projections 54, 56, wherein in this exemplary embodiment the shim elements 62, 64 rotate about the integral hinge joint 66, 68. The shim elements 62, 64 are thereby fastened to the part 15 on the wiper blade side non-detachably and therefore in a safe-mounting manner.

It can be seen in FIG. 6 f that the structure preassembled in this manner is processed by means of ultrasound sonotrodes 70. It can be seen in FIG. 6 g that the heads 58 and 60 have been integrally formed on the projections 52 and 60 by means of the sonotrodes 70.

In further process steps no longer depicted, the wiper strip 14 can now be inserted, the end caps 38 fitted and the connecting device completed where appropriate.

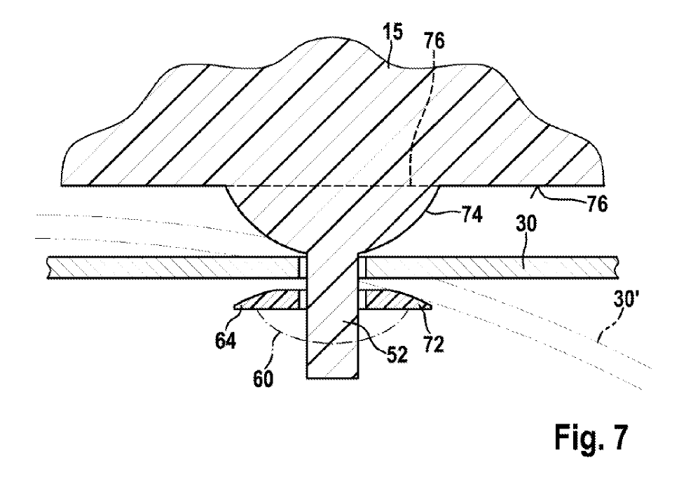

As shown in FIG. 7, in a further embodiment the surface 72 facing the spring strip 28, 30 may be convex in design. This improves mobility between the projection 52, 54 and the spring strip 28, 30 and reduces the notch effect in this region without having a detrimental effect on strength or dimensional accuracy.

Irrespective of this, the side facing the support element 12 of the part 15 on the wiper blade side may have a convex area 74 in the region of the projections 50, 52, by means of which a roll-off of the spring strips 28, 30 relative to the part 15 on the wiper blade side is possible. This area means that a space is created between the spring strip 28, 30 and the side 76 of the part 15 on the wiper blade side facing the spring strip, said space creating the clearance required to change the curvature of the spring strip 28, 30. The way in which the spring strip 30′ with the adapted curvature path is positioned is depicted in an exaggerated manner with a dot-dash line in FIG. 7.

The convex area 74 may be configured independently of the shim elements 52, 54. It is also possible for the convex region 74 not to be integrally formed on the part 15 on the wiper blade side but configured as a separate shim, which is indicated by the line 76 in FIG. 7. In this way, the notch effect can be reduced, as already mentioned.

In the exemplary embodiments the shim elements are depicted as individual parts, wherein a shim element is assigned to each projection. It is also possible, however, for the shim elements to be designed such that they exhibit a plurality of openings for a plurality of projections. In addition, it is conceivable for only two or also more than four projections to be provided. Furthermore, it is possible for the shim elements to be provided from another material, for example from a metal, a glass fiber-reinforced plastic or the like. The spring strips may also be made of homogeneous or coated plastic or the like. It also lies within the framework of the invention for shim elements or convex areas to be provided on all projections or only on selected ones.

1. A wiper blade for wiping windscreens, having a support element (12) for receiving a wiper strip (14) to which a connecting device (20) is fastened, said connecting device having a part (15) on a wiper blade side with projections (50, 52) which engage behind the support element (12) at least in places, characterized in that at least one shim element (62, 64) is arranged between engagement of the projections (50, 52) and the support element (12).

2. The wiper blade as claimed in claim 1, characterized in that the shim element (62, 64) is made of the same material as the part (15) on the wiper blade side.

3. The wiper blade as claimed in claim 1, characterized in that the shim element is integrally formed on the part (15) on the wiper blade side in an articulated manner.

4. The wiper blade as claimed in claim 1, characterized in that the shim element has at least one convex side (72) facing the support element (12).

5. The wiper blade for wiping windscreens, particularly vehicle windscreens, having a support element (12) for receiving a wiper strip (14) to which a connecting device (20) is fastened, said connecting device having a part (15) on a wiper blade side with projections (50, 52) which engage behind the support element (12) at least in places, characterized in that a side (76) of the part (15) on the wiper blade side facing the support element (12) has a convex area (74) in a region of the projections (50, 52).

6. The wiper blade as claimed in claim 5, characterized in that the convex area is formed by a separate shim element.

7. A method for producing a wiper blade as claimed in claim 1, characterized in that the part (15) of the connecting device (20) on the wiper blade side is placed on a convex upper side of the support element (12) such that the part penetrates the support element (12) with the projections (50, 52), that the at least one shim element (62, 64) is placed onto the projections (50, 52) and that projecting ends of the projections are thickened by means of heat and/or ultrasound.

8. The wiper blade as claimed in claim 6, wherein the shim element (62, 64) is arranged between engagement of the projections (50, 52) and the support element (12).
